(19) United States
(12) Patent Application Publication
(10) Pub. No.: US 2024/0380632 A1
(43) Pub. Date: Nov. 14, 2024

(54) RESTORATION OF FREQUENCY-DEPENDENT SIGNAL LOSS IN A FULL-DUPLEX DOCSIS DIRECTIONAL COUPLER

(71) Applicant: Comcast Cable Communications, LLC, Philadelphia, PA (US)

(72) Inventor: Richard PRODAN, Niwot, CO (US)

(21) Appl. No.: 18/659,746

(22) Filed: May 9, 2024

Related U.S. Application Data
(60) Provisional application No. 63/501,097, filed on May 9, 2023.

(51) Int. Cl. H04L 12/28; H04B 17/318; H04L 5/14

(52) U.S. Cl. CPC H04L 12/2801; H04B 17/318; H04L 5/14

(57) ABSTRACT

A system may comprise a transmitter associated with a content delivery network. The system may comprise a Full Duplex DOCSIS (FDX) coupler. The FDX coupler may be configured to receive, from the transmitter, at least one first signal, cause sending of the at least one first signal to at least one client device, receive, from the at least one client device, at least one second signal, and cause sending of the at least one second signal to a receiver associated with the content delivery network. The FDX coupler may cause a frequency-dependent signal loss associated with the at least one first signal to minimize signal loss through the coupler and maximize output power transfer. The transmitter may be configured to adjust a transmit power associated with the at least one first signal to inversely correspond to the frequency-dependent signal loss.

### CROSS-REFERENCE TO RELATED APPLICATIONS

This application claims the benefit of U.S. provisional Application No. 63/501,097 filed May 9, 2023, which is incorporated by reference in its entirety.

### BACKGROUND

To implement Full Duplex DOCSIS (FDX) radio frequency (RF) communication between a node (e.g., headend) and client devices (e.g., cable modems) located at a household, a frequency dependent FDX directional coupler may be utilized in the node. The frequency dependent FDX directional coupler may be configured to couple downstream signals transmitted from the node and received by the client devices and upstream signals transmitted from the client devices and received by the node. The inclusion of frequency dependent coupling of transmitted power at the node reduces the power amplifier maximum total power required to achieve the desired level at the output of the node. However, the frequency dependent FDX directional coupler may be associated with a frequency-dependent signal loss nonlinearity over a portion of the transmitted frequency band. Techniques for mitigating this frequency-dependent signal loss irregularity are desirable.

### SUMMARY

Systems, methods, and devices relating to restoring the linear power vs. frequency output of the power amplifier that is compromised by frequency-dependent signal loss associated with frequency dependent FDX directional couplers are described herein. An FDX coupler may be associated with a frequency-dependent signal loss that varies over a frequency range to minimize transmitted signal loss through the coupler and maximize output power transfer. To compensate for this frequency-dependent signal loss, a transmitter may be configured to adjust a transmit power associated with the transmission of at least one signal (e.g., downstream signal) to the FDX coupler. The transmitter may be configured to adjust the transmit power to inversely correspond to the frequency-dependent signal loss. Based on adjusting the transmit power, the transmitter may cause sending of the at least one signal to the FDX coupler. The FDX coupler may be configured to cause sending of the at least one signal to at least one client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF DRAWINGS

The accompanying drawings, which are incorporated in and constitute a part of this specification, illustrate embodiments and together with the description, serve to explain the principles of the systems, methods, and devices:

FIG. 1 is an example FDX cable system.

FIG. 2 is an example set of frequency dependent FDX coupler response graphs.

FIG. 3 is an example linear frequency response restoration method.

FIG. 4 is an example computing device.

Aspects of the disclosure will now be described in detail with reference to the drawings, wherein like reference numbers refer to like elements throughout, unless specified otherwise.

### DETAILED DESCRIPTION

To expand their service offerings, content providers may leverage existing cable television (CATV) network infrastructure to provide high-bandwidth data transfer (e.g., Internet access). For example, a subscriber (e.g., household) associated with the content provider may receive cable television and access the Internet via the same cable connection and network. DOCSIS (Data Over Cable Service Interface Specification) is one among several specifications that has been widely adopted to enable two-way data transfer over a CATV network. Full Duplex (FDX) DOCSIS is an extension of DOCSIS 3.1 (released in 2013) and provides for full duplex symmetrical upstream and downstream data transfer. Other legacy versions of DOCSIS (e.g., DOCSIS 3.0) also remain in common use. For example, a content provider may have some subscribers with DOCSIS 3.1-compatible cable modems and other subscribers with only DOCSIS 3.0-compatible cable modems.

At least in part to meet the greater bandwidth needs relating to the additional two-way data transfer, a hybrid fiber-coaxial (HFC) network may be implemented in which distributed nodes (e.g., optical nodes) are connected to a headend or other central location via optical fiber and the nodes are connected to client devices (e.g., cable modems) at the subscriber households via coaxial cable. In further evolutions, a distributed access architecture (DAA) may move some functions traditionally performed at a headend to the nodes. For example, a remote physical layer architecture (R-PHY) may move the modulation and demodulation functions to the nodes. A remote MAC-PHY (R-MACPHY) architecture may move the MAC layer processing to the nodes. One or more radio frequency (RF) amplifiers often may be used in the coaxial portions of an HFC network to boost signal power.

To implement Full Duplex (FDX) radio frequency (RF) communication between a node and a client device (e.g., cable modem) at a subscriber household, an FDX directional coupler (e.g., in a node's RF front end) may be used to couple a downstream signal and an upstream signal which occupy the same frequency band in a portion of the RF spectrum. This may require the use of a directional coupler rather than a traditional diplex filter where the downstream and upstream signals occupy separate frequency bands. The FDX node may include a computing device (e.g., digital signal processor), analog-to-digital converters (ADC), digital-to-analog converters (DAC), power level and distortion control, and downstream echo cancellation associated with removing the reflected signal (e.g., echo) from the downstream output of a node coupled into the upstream signal input. For example, the insertion loss of the FDX coupler may cause a downstream output power loss. This power loss must be overcome by increasing the power amplifier output level which may exceed the amplifier distortion-free total power limit.

To overcome this output power loss without exceeding the total power limit, the output signal power may be increased (e.g., boosted) by reducing the insertion loss in the DOCSIS 3.1/FDX downstream band from 1002 to 1218 MHz. Increasing the signal power in this manner may not change the total composite power of the FDX linear power profile while lowering the required total output power of the power amplifier into the FDX coupler. Thus, increasing the signal power in this manner may restore the lost power in the band above 1002 MHz and may preserve the power received by legacy cable modems in the network.

To reduce the power loss in the band above 1002 MHz due to the fixed coupling factor and resultant insertion loss (main line loss) of a conventional directional coupler, a frequency dependent FDX directional coupler may be used. The frequency dependent FDX directional coupler may be associated with a gradually tapered power loss profile in a particular frequency range (e.g., approximately between the upper frequency limit of the 108 MHz to 684 MHz FDX band and the lower frequency limit of the 1002 MHz to 1218 MHzband). However, the gradual tapering in through port insertion loss associated with the frequency dependent FDX directional coupler may cause a nonlinear power irregularity in the transitional frequency range (e.g., approximately between the 684 MHz FDX upper frequency limit and the 1002 MHz lower frequency limit of the 1002 MHz to 1218 MHz band). Described herein are systems, methods, and devices that may be utilized to overcome this nonlinear power irregularity.

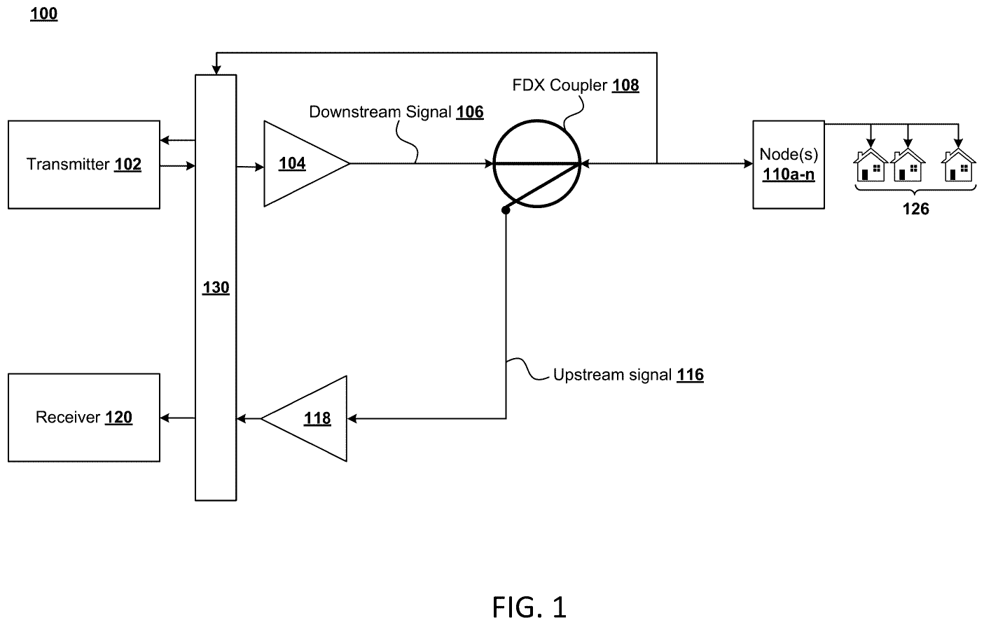

FIG. 1 illustrates a block diagram of a system 100 in which the present systems, methods, and devices may be implemented. The system 100 may be configured to provide cable television (CATV) and/or Internet access to one or more client devices 126 (e.g., households, subscribers, etc.) The system 100 may additionally or alternatively provide telephony service (e.g., voice over Internet protocol (VoIP)) for the plurality of client devices. The system 100 may comprise a hybrid fiber-coaxial (HFC) network. Additionally or alternatively, the system 100 may be configured, at least in part, according to a distributed access architecture (DAA). Additionally or alternatively, the system 100 may be configured, at least in part, according to a remote physical layer architecture (R-PHY) and/or a remote MAC-PHY (R-MACPHY) architecture. To enable Internet access or other two-way data transfer for the plurality of client devices, the system 100 may be configured, at least in part, to operate according to the DOCSIS specification, such as DOCSIS 3.0 (or earlier versions), DOCSIS 3.1, and/or DOCSIS 4.0. The system 100 may be configured to support more than one DOCSIS specification. For example, some of the plurality of client devices may have a newer DOCSIS 4.0 FDX-compatible cable modem while other households may have an older cable modem configured for only DOCSIS 3.1 or earlier.

The client device(s) 126 may comprise any one of numerous types of devices configured to receive video data, such as an MPEG-2 transport stream, and decode the received video data for viewer consumption. The client device(s) 126 may comprise a display device, such as a television display. The client device(s) 126 may comprise a computing device, such as a laptop computer or a desktop computer. The client device(s) 126 may comprise a mobile device, such as a smart phone or a tablet computer. The client device(s) 126 may be configured to receive video content and output the video content to a separate display device for consumer viewing. For example, the client device(s) 126 may comprise a set-top box, such as a cable set-top box. A set-top box may receive video content via a cable input (e.g., co-axial cable) and format the received video content for output to a display device. A set-top box, such as a multimedia gateway device, may receive video content via digital video streaming.

The system 100 may be configured to operate in a full duplex (FDX) mode (e.g., FDX DOCSIS 4.0) in which downstream and upstream data is sent and received. The downstream data may be sent to the client device(s) 126 and upstream data received from the client device(s) 126 via one or more nodes 110a-n simultaneously. In FDX mode, the upstream frequency band and the downstream frequency band may overlap, at least in part. FDX mode may be implemented with an eventual goal of achieving equal upstream and downstream transfer rates (e.g., 10 Gb/s downstream and 10 Gb/s upstream), but this is not required. The system 100 may be configured to support more than one DOCSIS specification. For example, some of the plurality of client devices may have a newer DOCSIS 4.0 FDX-compatible cable modem while other of the plurality of client devices may have a cable modem configured for only DOCSIS 3.1 or earlier.

The system 100 may comprise a transmitter 102. The transmitter 102 may be associated with a headend (e.g., central location). The transmitter 102 may receive content (e.g., data, video programming, and the like) from one or more content sources for distribution to various client devices (or similar location or premises) via the node(s) 110a-n. Content may comprise linear programming and/or on-demand programming. Video programming may include television shows, movies, sports events, news programming, etc. Content may additionally or alternatively comprise audio content, such as a music stream or radio programming. The content source may comprise a direct feed source or a satellite source. The content source may additionally or alternatively comprise a capture device, such as a video camera, or a server. The transmitter 102 may receive content from the content source, for example, via a wireless channel (e.g., satellite), a terrestrial path, and/or a direct line. The transmitter 102 may be connected to (e.g., in communication with) a transmitter power amplifier 104. The transmitter power amplifier 104 may be configured to amplify downstream signals to expected (e.g., necessary) levels. As used herein, “downstream” shall refer to the data flow direction going from the transmitter 102 towards the node(s) 110a-n (e.g., from the transmitter 102 towards the client device(s) 126).

The system 100 may comprise a transmitter 102. The transmitter 102 may be associated with the headend. The transmitter 102 may receive content (e.g., data, video programming, and the like) from the headend. Content may comprise linear programming and/or on-demand programming. Video programming may include television shows, movies, sports events, news programming, etc. Content may additionally or alternatively comprise audio content, such as a music stream or radio programming. The content source may comprise a direct feed source or a satellite source. The content source may additionally or alternatively comprise a capture device, such as a video camera, or a server. The receiver 120 may receive content from the one or more client devices, for example, via a wireless channel (e.g., satellite), a terrestrial path, and/or a direct line. The receiver 120 may be connected to (e.g., in communication with) a receiver amplifier 118. The receiver amplifier 118 may be configured to amplify upstream signals to expected (e.g., necessary) levels. As used herein, “upstream” shall refer to the data flow direction going from the node(s) 110a-n towards the receiver 120 (e.g., from the client device(s) 126 towards the receiver 120).

The node(s) 110a-n may be configured to enable upstream and downstream data transfer between the headend and the client device(s) 126. To this end, the node(s) 110a-n may be in communication with the transmitter 102 and/or the receiver 120 via respective fiber optic lines from the headend. The upstream and downstream data carried over the fiber optic lines may, for example, be in the form of a digital signal or an analog signal.

The system 100 may comprise a FDX coupler 108. The FDX coupler 108 may be a frequency dependent FDX directional coupler. The FDX coupler 108 may be configured to direct a transmitted downstream signal 106 from the transmitter 102 to the node(s) 110a-n. The node(s) 110a-n may then send (e.g., forward) the downstream signal 106 to the client device(s) 126. The FDX coupler 108 may be configured to direct an upstream signal 116 received at the node(s) 110a-n (from the client device(s) 126) to the receiver 120.

The FDX coupler 108 may be associated with a set of conflicting requirements. For example, it may be desirable that the FDX coupler 108 is associated with high coupling in the frequency band(s) where such high coupling is required and high main line loss is tolerable, and low coupling in the frequency band(s) where such low coupling is tolerable and low main line loss is required.

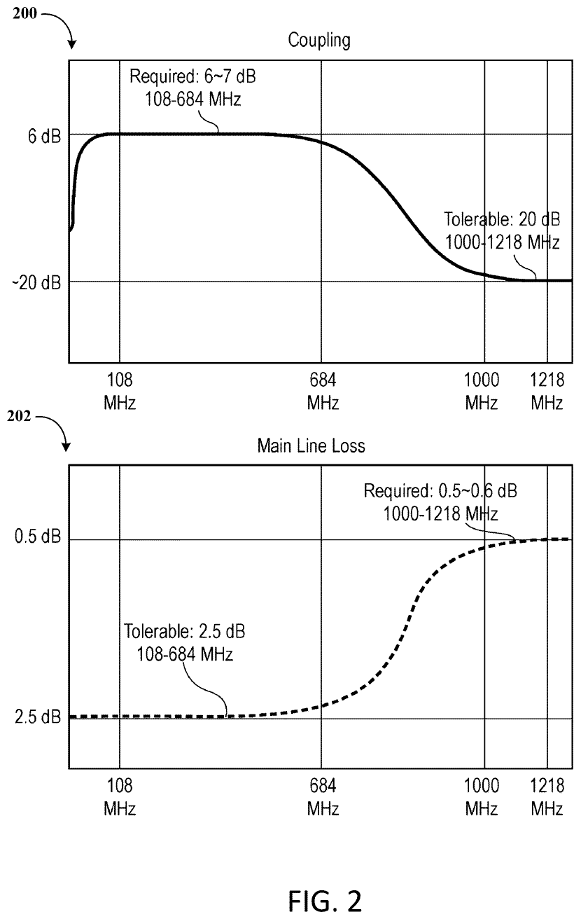

FIG. 2 shows a set of graphs illustrating an example of conflicting FDX coupler requirements. The graph 200 shows the amount of required signal power coupling associated with the FDX coupler 108 with respect to frequency. The graph 202 shows the amount of main line loss associated with the FDX coupler 108. As shown in the example of FIG. 2, the amount of signal power coupling and the amount of main line loss conflict with each other. In particular, high coupling is desired in the FDX frequency band (108-684 MHz) to minimize upstream receive signal loss and optimize upstream receiver performance, and a low main line loss is desired at high downstream frequencies (e.g., 1000-1218 MHz).

Referring back to FIG. 1, the FDX coupler 108 may be configured to compensate for (e.g., restore) power loss at high downstream frequencies (e.g., in the FDX band from about 1000 MHz to 1218 MHz). However, as shown in the graph 202 of FIG. 2, the FDX coupler 108 may be associated with a gradually tapered power loss profile in a particular frequency range (e.g., approximately between the 684 MHz FDX upper frequency limit and the 1002 MHz lower frequency limit of the 1000-1218 MHz band). The gradual tapering may be, for example, non-linear.

The gradual tapering in through port loss associated with the FDX coupler 108 may cause a frequency-dependent power irregularity (e.g., signal loss) in a frequency range that is about 684 MHz FDX to 1002 MHz. The FDX coupler 108 may cause a frequency-dependent signal loss associated with the transmission of the downstream signal 106 to the node(s) 110a-n. The frequency-dependent signal loss may, for example, be a non-linear signal loss. For example, the frequency-dependent signal loss may vary (e.g., non-linearly) over the frequency range that is about 684 MHz FDX to 1002 MHz.

The transmitter 102 may be configured to adjust a transmit power associated with transmission of the downstream signal 106 at the output of the FDX coupler 108. For example, the transmitter 102 may be configured to adjust a transmit power associated with transmission of the downstream signal 106 to compensate for the frequency-dependent signal loss associated with the transmission of the downstream signal 106 to the node(s) 110a-n. To adjust the transmit power associated with transmission of the downstream signal 106 to compensate for the frequency-dependent signal loss, the transmitter 102 output may be adjusted through the digital signal processor 130 such that the downstream signal 106 inversely corresponds to the frequency-dependent signal loss by sampling the output of the FDX coupler to calculate the inverse pre-distortion in the digital signal processor 130 and adjust the transmitter 102 output to the power amplifier 104. As discussed above, the frequency range adjustment may comprise frequencies from about 684 MHz to 1 GHz.

If the frequency-dependent signal loss varies non-linearly over the frequency range (as shown in the graph 202 of FIG. 2), a linear ramp in the power profile between the frequencies of about 684 MHz to 1 GHz may not fully restore the FDX power profile. Thus, instead of basing the transmission power adjustment on a linear ramp, the transmission power may be adjusted to match the exact, or almost exact, inverse of the FDX coupler power profile.

To adjust the transmit power associated with transmission of the downstream signal 106, the digital signal processor 130, using the sampled output of the FDX coupler 108, may determine a frequency associated with the downstream signal 106. The frequency may be in the frequency range from about 684 MHz to 1 GHz. Based on the determined frequency, the digital signal processor 130 may determine the frequency dependent signal loss. For example, the transmitter 102 may determine the frequency dependent signal loss associated within the determined frequency range containing the nonlinearity at the FDX coupler output.

Determining the frequency dependent signal loss may be based on pre-stored data indicating the variation of the frequency-dependent signal loss over the frequency range from about 684 MHz to 1 GHz. The pre-stored data may be stored in the digital signal processor 130 or in a database accessible by the digital signal processor 130. For example, the pre-stored data may have been generated and stored before being implemented in the system 100 (e.g., at the time of manufacture of the system 100).

The digital signal processor 130 may determine the frequency dependent signal loss based on real time data measuring the variation of the frequency-dependent signal loss at the output of the FDX coupler 108 over the frequency range from about 684 MHz to 1 GHz. The digital signal processor 130 may be configured to determine the real time data indicating the variation of the frequency-dependent signal loss over the frequency range. For example, the digital signal processor 130 may be configured to determine the real time data indicating the variation of the frequency-dependent signal loss over the frequency range by measuring a real time signal response associated with the downstream signal 106 at the output of the FDX coupler 108.

The digital signal processor 130 may comprise a directional coupler configured to sample a downstream output signal of the FDX coupler 108 with an ADC. The digital signal processor 130 may be configured to store information (e.g., data, reference information) indicating a desired transmitted output power versus frequency. The information may be used to compute the real time data indicating the variation of the frequency-dependent signal loss over the frequency range sent to the power amplifier 104. The variation of the frequency-dependent signal loss over the frequency range may be caused by a decreased main line loss versus frequency associated with the FDX coupler 108.

The digital signal processor 130 may be configured to cause sending of the downstream signal 106 to the FDX coupler 108. Sending of the downstream signal 106 to the FDX coupler 108 may be based on the determined frequency dependent signal loss. For example, the digital signal processor 130 may cause sending of the downstream signal 106 to the FDX coupler 108 based on adjusting a transmit power associated with the downstream signal 106 to inversely correspond to the determined frequency-dependent signal loss of the FDX coupler. The FDX coupler 108 may be configured to cause sending of the adjusted downstream signal 106 to the client device(s) 126.

To adjust a transmit power associated with the downstream signal 106 to inversely correspond to the determined frequency-dependent signal loss, the digital signal processor 130 may be configured to add the inverse of the variation of the frequency-dependent signal loss over the frequency range to a linear power versus frequency transmitter signal. Adding the inverse of the variation of the frequency-dependent signal loss over the frequency range to the linear power versus frequency transmitter signal may reduce an increase in output power at frequencies above the FDX band at the output of the FDX coupler 108. This reduction of transmit power above the FDX band may cause the linear power versus frequency to be restored at the output of the FDX coupler 108. The processed and transmitted downstream signal 106 may compensate (e.g., exactly, or almost exactly) for the reduced main line loss associated with the FDX coupler 108. If the transmitted downstream signal 106 compensates (e.g., exactly, or almost exactly) for the reduced main line loss associated with the FDX coupler 108, a reduced downstream signal 106 may be applied at higher frequencies. Applying a reduced downstream signal 106 at higher frequencies may lower the total output power of the transmitter power amplifier 104 while ensuring that the linear monotonically increasing output power versus frequency matches the desired output power level and linear up-tilt.

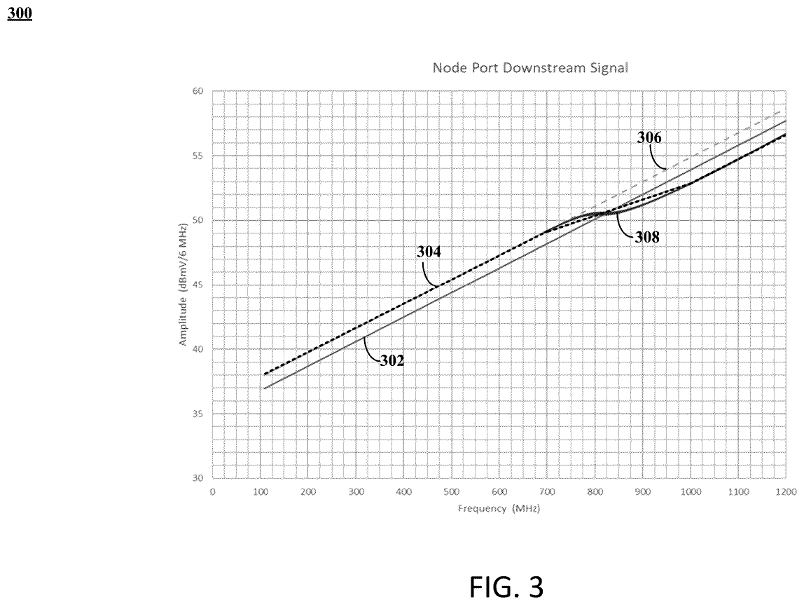

FIG. 3 shows a graph 300 illustrating an example of an inverse coupler loss transition applied to an input of a transmitter power amplifier (e.g., transmitter power amplifier 104). The line 302 may represent the desired amplitude versus frequency response for an FDX node downstream output. Line 306 represents the power amplifier 104 output downstream signal 106 required to overcome the insertion loss of a standard FDX directional coupler with a fixed insertion loss over the entire 108 MHz to 1218 MHz downstream band. Such power amplifier 104 increased level can exceed the maximum total power limit of the power amplifier 104 due to the increased power contribution above 1000 MHz. The conventional solution to limit this power increase would be to abruptly drop the downstream signal 106 power by several dB above 1000 MHz to reduce the total power to within the total power limit of the power amplifier 104. The output power loss in this frequency band may lower the signal-to-noise ratio and corresponding capacity delivered to the client devices 126.

This output power loss may be overcome by utilizing the FDX directional coupler 108 with frequency dependent coupling and main line loss by decreasing the coupling and associated main line loss above 1000 MHz. Both the coupling and associated main line loss may be unchanged in the FDX band below 684 MHz. The digital signal processor 130 shapes the frequency response of the input to the power amplifier 104 to approximately match the inverse of the insertion loss of the FDX coupler in the FDX and 1000 MHz to 1218 MHz bands. The resulting inverse lower output power frequency response of the power amplifier 104 is shown in line 304. Line 304 shows a linear taper between 684 MHz and 1000 MHz which approximates the FDX coupler 108 main line loss in this transitional frequency band rather than the conventional abrupt drop at 1000 MHz.

However, the gradual tapering in through port loss may result in a non-linear power irregularity between these frequency limits. While this non-linear power irregularity may be partially overcome with a linear ramp in the power profile between these frequency limits while maintaining the same overall total composite power, it may be better overcome if the exact inverse of the directional coupler profile replaces the linear ramp. The line 308 may represent the inverse coupler loss transition that may be applied to an input of a transmitter power amplifier (e.g., transmitter power amplifier 104). Replacing the linear ramp in the power profile with the exact inverse of the directional coupler profile, as depicted by the line 308, may restore the linear FDX coupler output power profile to line 306 (e.g., a linear line) with the same overall output total composite power but a reduced power amplifier output total composite power due to the decreased main line loss of the FDX coupler 108 above the FDX band limit at 684 MHz.

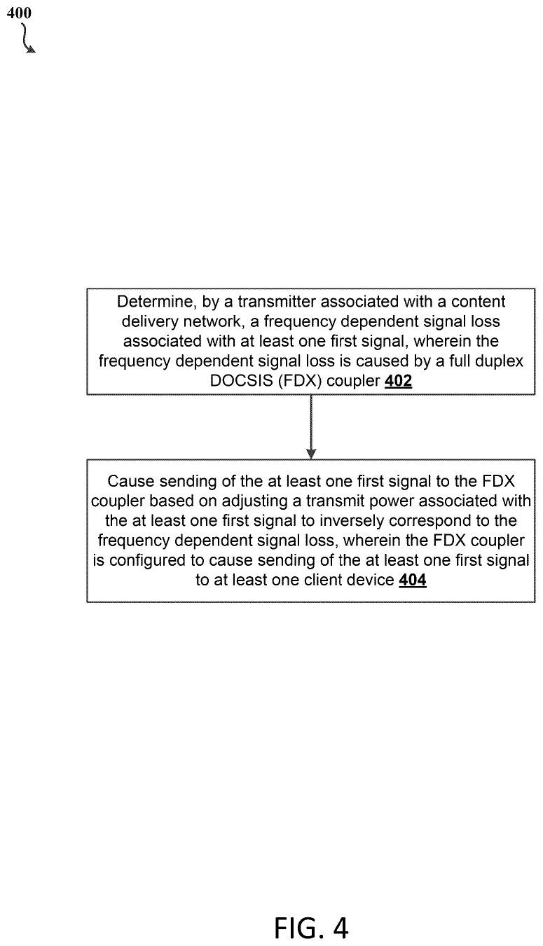

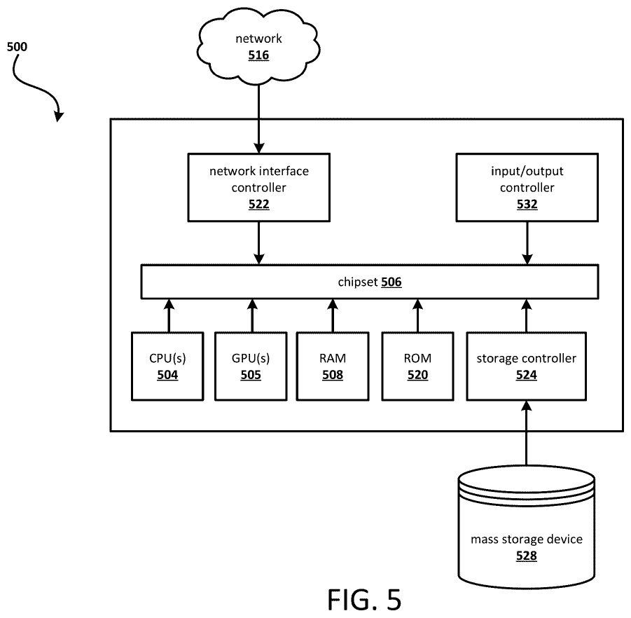

FIG. 4 shows a method 400. The method 400 may comprise a digital signal processor implemented method for adjusting transmit power. A system and/or computing environment, such as the system 100 of FIG. 1 and/or the computing environment of FIG. 4, may be configured to perform the method 400. For example, the digital signal processor 130 of FIG. 1 may be configured to perform the method 400.

At 402, a frequency-dependent signal loss may be determined. The frequency-dependent signal loss may be determined by a transmitter associated with a content delivery network. The frequency-dependent signal loss may be associated with at least one first signal. The at least one first signal may, for example, be a downstream signal. The at least one first signal may be associated with a frequency in a range of frequencies. The range of frequencies may be about 684 MHz to 1218 MHz. The frequency-dependent signal loss may vary over the range of frequencies. For example, the frequency-dependent signal loss may vary non-linearly over the range of frequencies between 684 MHz to 1000 MHz.

Determining the frequency dependent signal loss associated with at least one first signal may be based on pre-stored data. The pre-stored data may indicate the variation of the frequency-dependent signal loss over the range of frequencies. Additionally, or alternatively, determining the frequency dependent signal loss associated with at least one first signal may be based on real time data. The real time data may indicate the variation of the frequency-dependent signal loss over the range of frequencies. The real time data indicating the variation of the frequency-dependent signal loss over the range of frequencies may be determined by a computing device. The computing device may be configured to determine the real time data indicating the variation of the frequency-dependent signal loss over the range of frequencies by measuring a real time signal response associated with the at least one first signal at the output of the FDX coupler.

The frequency-dependent signal loss may be caused by a FDX coupler. The FDX coupler may be configured to receive, from at least one client device, at least one second signal (e.g., at least one upstream signal). The FDX coupler may be configured to cause sending of the at least one second signal to a receiver associated with the content delivery network.

At 404, sending of the at least one first signal to the FDX coupler may be caused. The sending of the at least one first signal to the FDX coupler may be caused based on adjusting a transmit power associated with the at least one first signal. The transmit power associated with the at least one first signal may be adjusted to inversely correspond to the frequency-dependent signal loss of the FDX coupler. Adjusting the transmit power associated with the at least one first signal to inversely correspond to the frequency-dependent signal loss may comprise adjusting the transmit power to inversely match the variation of the frequency-dependent signal loss over the range of frequencies restoring the desired linear output power profile over the entire downstream frequency band. The FDX coupler may be configured to cause sending of the at least one first signal to the at least one client device.

FIG. 5 depicts an example computing device in which the systems, methods, and devices disclosed herein, or all or some aspects thereof, may be embodied. For example, components such as the transmitter 102, the FDX coupler 108, the digital signal processor 130, the node(s) 110a-n, the client device(s) 126, and the receiver 120 of FIG. 1 may be implemented generally incorporating a computing device, such as the computing device 500 of FIG. 5. The computing device of FIG. 5 may be all or part of a server, workstation, desktop computer, laptop, tablet, network appliance, PDA, e-reader, digital cellular phone, set top box, or the like, and may be utilized to implement any of the aspects of the systems, methods, and devices described herein.

The computing device 500 may include a baseboard, or “motherboard,” which is a printed circuit board to which a multitude of components or devices may be connected by way of a system bus or other electrical communication paths. One or more central processing units (CPUs) 504 may operate in conjunction with a chipset 506. The CPU(s) 504 may be standard programmable processors that perform arithmetic and logical operations necessary for the operation of the computing device 500.

The CPU(s) 504 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 504 may be augmented with or replaced by other processing units, such as GPU(s) 505. The GPU(s) 505 may comprise processing units specialized for but not necessarily limited to highly parallel computations, such as graphics and other visualization-related processing.

A chipset 506 may provide an interface between the CPU(s) 504 and the remainder of the components and devices on the baseboard. The chipset 506 may provide an interface to a random access memory (RAM) 508 used as the main memory in the computing device 500. The chipset 506 may further provide an interface to a computer-readable storage medium, such as a read-only memory (ROM) 520 or non-volatile RAM (NVRAM) (not shown), for storing basic routines that may help to start up the computing device 500 and to transfer information between the various components and devices. ROM 520 or NVRAM may also store other software components necessary for the operation of the computing device 500 in accordance with the aspects described herein.

The computing device 500 may operate in a networked environment using logical connections to remote computing nodes and computer systems through local area network (LAN) 516. The chipset 506 may include functionality for providing network connectivity through a network interface controller (NIC) 522, such as a gigabit Ethernet adapter. A NIC 522 may be capable of connecting the computing device 500 to other computing nodes over a network 516. It should be appreciated that multiple NICs 522 may be present in the computing device 500, connecting the computing device to other types of networks and remote computer systems.

The computing device 500 may be connected to a mass storage device 528 that provides non-volatile storage for the computer. The mass storage device 528 may store system programs, application programs, other program modules, and data, which have been described in greater detail herein. The mass storage device 528 may be connected to the computing device 500 through a storage controller 524 connected to the chipset 506. The mass storage device 528 may consist of one or more physical storage units. A storage controller 524 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 500 may store data on a mass storage device 528 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 528 is characterized as primary or secondary storage and the like.

For example, the computing device 500 may store information to the mass storage device 528 by issuing instructions through a storage controller 524 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 500 may further read information from the mass storage device 528 by detecting the physical states or characteristics of one or more particular locations within the physical storage units.

In addition to the mass storage device 528 described above, the computing device 500 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 500.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“ID-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 528 depicted in FIG. 5, may store an operating system utilized to control the operation of the computing device 500. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 528 may store other system or application programs and data utilized by the computing device 500.

The mass storage device 528 or other computer-readable storage media may also be encoded with computer-executable instructions, which, when loaded into the computing device 500, transforms the computing device from a general-purpose computing system into a special-purpose computer capable of implementing the aspects described herein. These computer-executable instructions transform the computing device 500 by specifying how the CPU(s) 504 transition between states, as described above. The computing device 500 may have access to computer-readable storage media storing computer-executable instructions, which, when executed by the computing device 500, may perform the methods described herein.

A computing device, such as the computing device 500 depicted in FIG. 5, may also include an input/output controller 532 for receiving and processing input from a number of input devices, such as a keyboard, a mouse, a touchpad, a touch screen, an electronic stylus, or other type of input device. Similarly, an input/output controller 532 may provide output to a display, such as a computer monitor, a flat-panel display, a digital projector, a printer, a plotter, or other type of output device. It will be appreciated that the computing device 500 may not include all of the components shown in FIG. 5, may include other components that are not explicitly shown in FIG. 5, or may utilize an architecture completely different than that shown in FIG. 5.

As described herein, a computing device may be a physical computing device, such as the computing device 500 of FIG. 5. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the systems, methods, and devices are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described systems, methods, and devices. When combinations, subsets, interactions, groups, etc., of these components are described, it is understood that while specific references to each of the various individual and collective combinations and permutations of these may not be explicitly described, each is specifically contemplated and described herein, for all systems, methods, and devices. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the systems, methods, and devices may take the form of an entirely hardware embodiment, an entirely software embodiment, or an embodiment combining software and hardware aspects. Furthermore, the systems, methods, and devices may take the form of a computer program product on a computer-readable storage medium having computer-readable program instructions (e.g., computer software) embodied in the storage medium. More particularly, the present systems, methods, and devices may take the form of web-implemented computer software. Any suitable computer-readable storage medium may be utilized including hard disks, CD-ROMs, optical storage devices, or magnetic storage devices.

Embodiments of the systems, methods, and devices are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the systems, methods, and devices have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A system comprising:
a transmitter associated with a content delivery network; and
a full duplex DOCSIS (FDX) coupler configured to:
receive, from the transmitter, at least one first signal;
cause sending of the at least one first signal to at least one client device;
receive, from the at least one client device, at least one second signal; and
cause sending of the at least one second signal to a receiver associated with the content delivery network;
wherein the FDX coupler causes a frequency-dependent signal loss associated with the at least one first signal, and wherein the transmitter is configured to adjust a transmit power associated with the at least one first signal to inversely correspond to the frequency-dependent signal loss.

2. The system of claim 1, wherein the at least one first signal is associated with a frequency in a range of frequencies, and wherein the frequency-dependent signal loss varies over the range of frequencies.

3. The system of claim 2, wherein the transmitter is configured to adjust the transmit power associated with the at least one first signal to inversely correspond to the frequency-dependent signal loss by adjusting the transmit power to inversely match the variation of the frequency-dependent signal loss over the range of frequencies.

4. The system of claim 2, wherein the range of frequencies is about 684 MHz to 1 GHz.

5. The system of claim 2, wherein the transmitter is further configured to determine the frequency dependent signal loss based on pre-stored data indicating the variation of the frequency-dependent signal loss over the range of frequencies.

6. The system of claim 2, wherein the transmitter is further configured to determine the frequency dependent signal loss based on real time data indicating the variation of the frequency-dependent signal loss over the range of frequencies.

7. The system of claim 6, further comprising a computing device in communication with the transmitter, wherein the computing device is configured to determine the real time data indicating the variation of the frequency-dependent signal loss over the range of frequencies by measuring a real time signal response associated with the at least one first signal.

8. A method comprising:
determining, by a transmitter associated with a content delivery network, a frequency-dependent signal loss associated with at least one first signal, wherein the frequency-dependent signal loss is caused by a full duplex DOCSIS (FDX) coupler; and
causing sending of the at least one first signal to the FDX coupler based on adjusting a transmit power associated with the at least one first signal to inversely correspond to the frequency-dependent signal loss, wherein the FDX coupler is configured to cause sending of the at least one first signal to at least one client device.

9. The method of claim 8, wherein the FDX coupler is further configured to:
receive, from the at least one client device, at least one second signal; and
cause sending of the at least one second signal to a receiver associated with the content delivery network.

10. The method of claim 8, wherein the at least one first signal is associated with a frequency in a range of frequencies, and wherein the frequency-dependent signal loss varies over the range of frequencies.

11. The method of claim 10, wherein adjusting the transmit power associated with the at least one first signal to inversely correspond to the frequency-dependent signal loss comprises adjusting the transmit power to inversely match the variation of the frequency-dependent signal loss over the range of frequencies.

12. The method of claim 10, wherein determining the frequency dependent signal loss associated with the at least one first signal is based on pre-stored data indicating the variation of the frequency-dependent signal loss over the range of frequencies.

13. The method of claim 10, wherein determining the frequency dependent signal loss associated with the at least one first signal is based on real time data indicating the variation of the frequency-dependent signal loss over the range of frequencies.

14. The method of claim 13, wherein the real time data indicating the variation of the frequency-dependent signal loss over the range of frequencies is determined by a computing device in communication with the transmitter, and wherein the computing device is configured to determine the real time data indicating the variation of the frequency-dependent signal loss over the range of frequencies by measuring a real time signal response associated with the at least one first signal.

15. A device comprising:
one or more processors; and
memory storing instructions that, when executed by the one or more processors, cause the device to:
determine a frequency-dependent signal loss associated with at least one first signal, wherein the frequency-dependent signal loss is caused by a full duplex DOCSIS (FDX) coupler; and
cause sending of at least one first signal to the FDX coupler based on adjusting a transmit power associated with the at least one first signal to inversely correspond to the frequency-dependent signal loss, wherein the FDX coupler is configured to cause sending of the at least one first signal to at least one client device.

16. The device of claim 15, wherein the at least one first signal is associated with a frequency in a range of frequencies, and wherein the frequency-dependent signal loss varies over the range of frequencies.

17. The device of claim 16, wherein adjusting the transmit power associated with the at least one first signal to inversely correspond to the frequency-dependent signal loss comprises adjusting the transmit power to inversely match the variation of the frequency-dependent signal loss over the range of frequencies.

18. The device of claim 16, wherein the instructions that, when executed by the one or more processors, cause the device to determine the frequency-dependent signal loss associated with the at least one first signal, comprise instructions that, when executed by the one or more processors, cause the device to:
determine the frequency dependent signal loss associated with the at least one first signal based on pre-stored data indicating the variation of the frequency-dependent signal loss over the range of frequencies.

19. The device of claim 16, wherein the instructions that, when executed by the one or more processors, cause the device to determine the frequency-dependent signal loss associated with the at least one first signal, comprise instructions that, when executed by the one or more processors, cause the device to:
determine the frequency dependent signal loss associated with the at least one first signal based on real time data indicating the variation of the frequency-dependent signal loss over the range of frequencies.

20. The device of claim 19, wherein the real time data indicating the variation of the frequency-dependent signal loss over the range of frequencies is determined by a computing device in communication with the device, and wherein the computing device is configured to determine the real time data indicating the variation of the frequency-dependent signal loss over the range of frequencies by measuring a real time signal response associated with the at least one first signal.
